(19) United States
(12) Patent Application Publication
(10) Pub. No.: US 2018/0281034 A1
(43) Pub. Date: Oct. 4, 2018

(54) SYSTEMS AND METHODS FOR PROCESSING RESTAURANT WASTE

(71) Applicant: Dean Lavallee, Palm City, FL (US)

(72) Inventor: Dean Lavallee, Palm City, FL (US)

(21) Appl. No.: 15/119,750

(22) PCT Filed: Feb. 19, 2015
(86) PCT No.: PCT/US15/16599

§ 371 Date: Nov. 18, 2016

Related U.S. Application Data
(60) Provisional application No. 61/941,714, filed on Feb. 19, 2014.

(51) Int. Cl. B09B 3/00

(52) U.S. Cl. CPC B09B 3/0025

(57) ABSTRACT

Processes and systems for utilizing restaurant waste are provided. The restaurant waste may include food products, paper products, glass products, plastic products, and combinations thereof. The process may include grinding the restaurant waste to produce ground restaurant waste, having a maximum particle size of about 0.075 mm; forming a slurry comprising the ground restaurant waste and water; and maintaining the slurry at a pH greater than about 7 in a storage container. The slurry and/or the ground restaurant waste may be sterilized and fed to one or more digestive organisms, including but not limited to worms, bacteria, fungi, molds, and combinations thereof.

### CROSS-REFERENCE TO RELATED APPLICATIONS

This application claims priority to U.S. Provisional Application 61/941,714, filed Feb. 19, 2014, the complete disclosure of which is incorporated herein by reference in its entirety.

### FIELD

The present disclosure relates generally to processing restaurant waste and more particularly to processing restaurant waste into a slurry.

### BACKGROUND

Restaurant waste, including food products, is a large contributor to adverse environmental conditions, injury from food waste disposal, and food borne disease. With respect to adverse environmental conditions, discarded food waste contributes to both increased landfill volume and to increased cost of maintaining water treatment facilities. For example, consumer households typically discard wet and soft food waste into garbage disposals that feed into water treatment facilities. Additionally, consumer households typically discard remaining hard food waste into trash cans that are emptied into landfills. Furthermore, commercial kitchens typically discard wet, soft, and certain categories of hard food waste into industrial grinders that feed into water treatment facilities. Furthermore, commercial kitchens typically discard paper and remaining hard food waste into dumpsters that are emptied into landfills.

With respect to injuries associated with food waste disposal, food waste is typically discarded into trash cans that are carried out to dumpsters or deposited curb-side for pick-up. Injuries generally result from slip-and-fall accidents arising from heavy lifting and/or slippery conditions caused by spilling of grease and oils.

Furthermore, if left untreated, food waste that is discarded into trash cans and dumpsters may become a source of disease. For example, meats and dairy products may spoil if left unrefrigerated and may become a health hazard to humans and animals. Additionally, any food waste that is discarded into trash cans and dumpsters may become a food source for rodents and other undesirable creatures.

### BRIEF DESCRIPTION OF THE DRAWINGS

Implementations of the present technology will now be described, by way of example only, with reference to the attached figures, wherein:

FIG. 1 illustrates a block diagram of a food waste processing system according to one example of the disclosure;

FIG. 2 illustrates a flowchart of an example method according to the present disclosure; and

FIG. 3 illustrates a block diagram of the computer according to one example of the disclosure.

### DETAILED DESCRIPTION

A need exists for improving how food waste is processed in order to reduce adverse environmental effects. Furthermore, a need exists for reducing other detrimental effects associated with food waste such as rodent infestation, food-based contamination, injury from food waste disposal, filling of landfills and increased cost of maintaining water treatment facilities.

Nutrients derived from food waste may be processed according to examples described herein to enhance agricultural production. According to one example, food waste may be processed into slurry that is converted into fertilizer through vermiculture or vermicomposting. For example, the slurry may be stored for a predetermined amount of time to obtain desired characteristics and then the processed slurry may be introduced into soil for consumption by worms. The worms may digest the processed slurry to produce compost that is applied as fertilizer for agricultural purposes, among other purposes.

According to one example, systems and methods are provided for converting food waste into slurry that is consumed by worms or the like. The food waste may include any food items associated with human and/or animal consumption. The technology also includes systems and methods for sanitizing the food waste to provide a disease-free product. For example, the food waste may be sanitized during processing, before processing, and/or after processing. According to one example, the technology may be applied in commercial and residential environments.

In commercial environments such as commercial kitchens, food waste may be received in various ways. For example, restaurant employees may retrieve food waste left behind on soiled dishes. Alternatively, restaurant employees may retrieve food waste from food inventory that is spoiled or otherwise not needed. One of ordinary skill in the art will readily appreciate that other sources of food waste are available.

Various embodiments relate to a process for utilizing restaurant waste comprising food products. The restaurant waste may be entirely or partially food waste and/or food products. The process may include grinding the restaurant waste to produce ground restaurant waste. The ground restaurant waste can have a maximum particle size within a range having a lower limit and/or an upper limit. The range can include or exclude the lower limit and/or the upper limit. The lower limit and/or upper limit can be selected from about 0.001, 0.002, 0.003, 0.004, 0.005, 0.006, 0.007, 0.008, 0.009, 0.01, 0.011, 0.012, 0.013, 0.014, 0.015, 0.016, 0.017, 0.018, 0.019, 0.02, 0.021, 0.022, 0.023, 0.024, 0.025, 0.026, 0.027, 0.028, 0.029, 0.03, 0.031, 0.032, 0.033, 0.034, 0.035, 0.036, 0.037, 0.038, 0.039, 0.04, 0.041, 0.042, 0.043, 0.044, 0.045, 0.046, 0.047, 0.048, 0.049, 0.05, 0.051, 0.052, 0.053, 0.054, 0.055, 0.056, 0.057, 0.058, 0.059, 0.06, 0.061, 0.062, 0.063, 0.064, 0.065, 0.066, 0.067, 0.068, 0.069, 0.07, 0.071, 0.072, 0.073, 0.074, 0.075, 0.076, 0.077, 0.078, 0.079, 0.08, 0.081, 0.082, 0.083, 0.084, 0.085, 0.086, 0.087, 0.088, 0.089, 0.09, 0.091, 0.092, 0.093, 0.094, 0.095, 0.096, 0.097, 0.098, 0.099, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, and 10 mm. For example, according to certain preferred embodiments, the ground restaurant waste can have a maximum particle size of about 0.075 mm.

The process for utilizing restaurant waste comprising food products may include forming a slurry comprising the ground restaurant waste and a suspension medium. As used herein, the term “slurry” generally means a semi-liquid mixture comprising particles suspended in a suspension medium. The suspension medium may be, but is not limited to, a liquid. The suspension medium may be any suitable suspension medium, including but not limited to water.

A slurry may be flowable under the influence of gravity at a temperature and a pressure. A slurry may be pumpable at the temperature and the pressure. The temperature can be within a range having a lower limit and/or an upper limit. The range can include or exclude the lower limit and/or the upper limit. The lower limit and/or upper limit can be selected from about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, and 75 degrees Celsius. For example, according to certain preferred embodiments, the temperature can be room temperature. The pressure can be within a range having a lower limit and/or an upper limit. The range can include or exclude the lower limit and/or the upper limit. The lower limit and/or upper limit can be selected from about 0.5, 0.6, 0.7, 0.8, 0.9, 1, 1.1, 1.2, 1.3, 1.4, 1.5, 1.6, 1.7, 1.8, 1.9, and 2 bar. For example, according to certain preferred embodiments, the pressure can be atmospheric pressure.

A slurry may be pumpable via a variety of types of pumps, including but not limited to positive displacement pumps, gear pumps, screw pumps, progressing cavity pumps, roots-type pumps, peristaltic pumps, plunger pumps, triplex-style plunger pumps, compressed-air-powered double diaphragm pumps, centripetal pumps, centrifugal pumps, gravity pumps, and combinations thereof.

A slurry may be flowable at the temperature, at the pressure, and under the influence of gravity through a variety a structures, including but not limited to pipes, tubes, and hoses. The structures can have a diameter within a range having a lower limit and/or an upper limit. The range can include or exclude the lower limit and/or the upper limit. The lower limit and/or upper limit can be selected from about 0.25, 0.5, 0.75, 1, 1.25, 1.5, 1.75, 2, 2.25, 2.5, 2.75, 3, 3.25, 3.5, 3.75, 4, 4.25, 4.5, 4.75, 5, 5.25, 5.5, 5.75, 6, 6.25, 6.5, 6.75, 7, 7.25, 7.5, 7.75, 8, 8.25, 8.5, 8.75, 9, 9.25, 9.5, 9.75, 10, 10.25, 10.5, 10.75, 11, 11.25, 11.5, 11.75, and 12 inches. For example, according to certain preferred embodiments, the slurry may be flowable at the temperature, at the pressure, and under the influence of gravity through a pipe having a diameter of from about 1 to 2 inches.

A slurry may comprise an effective amount of the suspension medium to ensure that the slurry is flowable under the influence of gravity at the temperature and at the pressure and/or pumpable at the temperature and at the pressure. The effective amount can vary depending on the temperature and the pressure. Generally, the slurry may comprise an amount of the suspension medium within a range having a lower limit and/or an upper limit. The range can include or exclude the lower limit and/or the upper limit. The lower limit and/or upper limit can be selected from about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, and 75% by weight based on the total weight of the slurry. For example, according to certain preferred embodiments, a slurry may comprise an amount of the suspension medium of from about 10 to 20% by weight based on the total weight of the slurry.

The process for utilizing restaurant waste comprising food products may further include maintaining the slurry in a storage container at a pH. The pH at which the slurry is maintained in the storage container can be within a range having a lower limit and/or an upper limit. The range can include or exclude the lower limit and/or the upper limit. The lower limit and/or upper limit can be selected from about 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, 12.2, 12.3, 12.4, 12.5, 12.6, 12.7, 12.8, 12.9, 13, 13.1, 13.2, 13.3, 13.4, 13.5, 13.6, 13.7, 13.8, 13.9, and 14. For example, according to certain preferred embodiments, the pH at which the slurry is maintained in the storage container can be greater than about 7, i.e., in an alkaline condition. Maintaining the slurry at an alkaline condition can serve to prevent or to minimize nitrification of the slurry. Nitrification is the process by which ammonia is converted to nitrites and then to nitrates. Nitrification naturally occurs in the environment, where it is carried out by specialized bacteria. Ammonia is produced by the breakdown of organic sources of nitrogen.

According to various embodiments, the restaurant waste may include food products, paper products, glass products, plastic products, and combinations thereof. The particle size of the various components may vary within the ground restaurant waste produced according to various embodiments. Any food, paper, glass, or plastic products in the ground restaurant waste can have a maximum particle size within a range having a lower limit and/or an upper limit. The range can include or exclude the lower limit and/or the upper limit. The lower limit and/or upper limit can be selected from about 0.001, 0.002, 0.003, 0.004, 0.005, 0.006, 0.007, 0.008, 0.009, 0.01, 0.011, 0.012, 0.013, 0.014, 0.015, 0.016, 0.017, 0.018, 0.019, 0.02, 0.021, 0.022, 0.023, 0.024, 0.025, 0.026, 0.027, 0.028, 0.029, 0.03, 0.031, 0.032, 0.033, 0.034, 0.035, 0.036, 0.037, 0.038, 0.039, 0.04, 0.041, 0.042, 0.043, 0.044, 0.045, 0.046, 0.047, 0.048, 0.049, 0.05, 0.051, 0.052, 0.053, 0.054, 0.055, 0.056, 0.057, 0.058, 0.059, 0.06, 0.061, 0.062, 0.063, 0.064, 0.065, 0.066, 0.067, 0.068, 0.069, 0.07, 0.071, 0.072, 0.073, 0.074, 0.075, 0.076, 0.077, 0.078, 0.079, 0.08, 0.081, 0.082, 0.083, 0.084, 0.085, 0.086, 0.087, 0.088, 0.089, 0.09, 0.091, 0.092, 0.093, 0.094, 0.095, 0.096, 0.097, 0.098, 0.099, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, and 10 mm. For example, according to certain preferred embodiments, any food, paper, glass, or plastic products in the ground restaurant waste can have a maximum particle size of about 0.075 mm.

The food products may include bones. Bones can provide a source of calcium within the slurry, which can be particularly useful in embodiments of the process further including feeding the slurry to worms at a vermiculture farm.

As discussed throughout the present disclosure, the process for utilizing restaurant waste comprising food products may include sterilizing the restaurant waste by exposing the ground restaurant waste to ultra-violet radiation, microwave radiation, heat energy, ozone, and combinations thereof. The restaurant waste may be sterilized prior to being ground or after being ground. Sterilizing ground restaurant waste may occur at any time, such as before or after the ground restaurant waste is added to the storage container. According to certain preferred embodiments, the sterilization occurs prior to adding the slurry to the storage container to ensure that all personnel who handle the storage container or transport the slurry to a secondary location are at minimal risk of any contamination or food-borne diseases.

The process for utilizing restaurant waste comprising food products may include agitating the slurry in the storage container. The storage container may be an airtight storage container.

The storage container can have a storage volume within a range having a lower limit and/or an upper limit. The range can include or exclude the lower limit and/or the upper limit. The lower limit and/or upper limit can be selected from about 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1100, 1200, 1300, 1400, 1500, 1600, 1700, 1800, 1900, and 2000 gallons. For example, according to certain preferred embodiments, the storage container can have a storage volume of at least 50 gallons.

The process for utilizing restaurant waste comprising food products may include pumping the slurry from the storage container to a tank of a vehicle and transporting the slurry to a processing facility. The vehicle may be any suitable vehicle, including but not limited to a tanker truck. The storage container may include a pumping connection 134 through which the slurry is pumped. The pumping connection may be positioned at any suitable location, including but not limited to a lower portion of the storage container. The lower portion may include a bottom surface of the storage container or a lower half of any side wall of the storage container. Positioning the pumping connection at a lower portion of the storage container can allow the slurry to flow through the pumping connection at least partially under the influence of gravity. Positioning the pumping connect at a lower portion of the storage container can also be helpful in cases where a portion of the suspended solids settle or otherwise fall out of the slurry.

The process for utilizing restaurant waste comprising food products may include feeding the slurry to one or more organisms at the processing facility. The one or more organisms may include worms, such as worms utilized at a vermiculture farm. The one or more organisms may include bacteria, fungi, molds, and combinations thereof, such as utilized at an anaerobic digestion facility. For purposes of the present disclosure “anaerobic digestion” is a series of biological processes in which microorganisms break down biodegradable material in the absence of oxygen. One of the end products is biogas, which is combusted to generate electricity and heat, or can be processed into renewable natural gas and transportation fuels.

The process may further include analyzing the slurry to identify a characteristic of the slurry; and adjusting the characteristic according to the requirements of the one or more digestive organisms. The characteristic may be any characteristic of the slurry as described herein, including but not limited to pH, water content, particle size, temperature, and combinations thereof.

Prior to feeding the slurry to the one or more organisms any harmful materials present within the slurry may be removed. For example, plastic materials, which tend to float in the slurry, may be skimmed out of the slurry. Additionally, any valuable components present in the slurry may be removed. For example, fats and oils, which also tend to float on top of the slurry, can be removed and sold as fuel. Separation of floating materials can be accomplished using any conventional methods, such as, passing the slurry through a baffled separation vessel.

The ranges and examples provided above with respect to various processes may also apply to the following system and apparatus examples.

According to one example, soiled dishes with food waste thereon including paper products such as napkins, may be placed in a pre-rinse area 102. The food waste may be deposited into a grinder 106 by scraping, water spray, or other cleansing technique. According to one example, the grinder 106 may receive wet, soft, and/or hard food waste and paper products. For example, the grinder 106 may include a blade 107 that blends the wet and soft food waste, along with paper products. Furthermore, the grinder 106 may include a smasher 109 that crushes the hard food waste, along with non-food items. For example, non-food items may include glass products or other non-food items.

Food waste and other items introduced into the system may include contaminants such as food borne diseases and customer-introduced contaminants, or the like. Therefore, as a safety precaution, the food waste and other items may be exposed to one or more sterilization processes such as through a sterilizer 110. For example, the food waste and other items may be exposed to ultra-violet radiation, microwave radiation, heat energy, and/or ozone, among other sterilizers.

According to one example, the processed food waste and other items may be deposited into a sealed storage container 114. For example, the storage container 114 may be adapted for long-term and/or short-term storage. Furthermore, the storage container 114 may include a hopper 116 that is configured to add selected ingredients to the food waste and other items. The ingredients or additives may provide catalysts for converting the food waste and other items into liquefied slurry 118 having desired characteristics. For example, the hopper 116 may be configured to add ingredients to the slurry 118 to promote desired characteristics, such as to neutralize odors or to deter consumption by rodents. Optionally, the storage container 114 further may include an agitator 120 that agitates the slurry 118, including by mixing, stirring, or the like. Alternatively, the storage container 114 may be a passive system that simply stores the slurry 118.

According to one example, the system 100 may include conveyors 104,108,112,113 or other transport mechanisms that transport the food waste between the pre-rinse area 102 and the storage container 114. For example, the conveyors 104,108,112,113 may include a belt drive, a gravity device, a suction device, a screw-type mechanism, or other conveyor.

The system 100 may include a computer 125 having a memory that stores computer readable instructions for execution by a processor to control various components including the grinder 106, the sterilizer 110, and components associated with the storage container 114 including the hopper 116 and agitator 120, among other components. Furthermore, the system 100 may include sensors 122a-122d distributed throughout the various components, including the grinder 106, the sterilizer 110, and components associated with the storage container 114 including the hopper 116 and agitator 120, among other components.

The computer 125 may be programmed with an algorithm that optimizes various system components based on the types of food waste and other items introduced into the system 100. For example, a speed of the blade 107 and smasher 109 may be adjusted based on the types of food waste and other items introduced into the grinder 106. For example, if glass bottles are introduced into the grinder 106, the blade 107 may be disabled and features of the smasher 109 may be optimized for crushing glass. Alternatively, if vegetables are introduced into the grinder 106, the smasher 109 may be disabled and features of the blade 107 may be optimized to blend the vegetables. Furthermore, if glass bottles and vegetables are both introduced into the grinder 106, then a sorting feature may be enabled to automatically separate the hard items from the soft items so that the soft items may be delivered to the blade 107 and the hard items may be delivered to the smasher 109. The sorting feature may include density sensors or other sensors that are capable of distinguishing between the hard items and the soft items.

Furthermore, sensors may be provided at the sterilizer 110 to determine types of food waste and other items introduced into the sterilizer 110. Based on this determination, the computer 125 may control components of the sterilizer 10 to energize and/or de-energize the ultra-violet radiation, the microwave radiation, and/or the heat energy, among other sources of energy. Furthermore, based on this determination, the computer 125 may control the speed of the conveyor through the sterilizer 110 to obtain optimal sterilization.

Additionally, the storage container 114 may include sensors such as pH sensors, humidity sensors, particle-size sensors, bacteria sensors, inside and outside temperature sensors, chemical sensors, slurry level sensors, and other sensors. Based on sensor data, the computer 125 may control components of the system 100 to optimize conditions within the storage container 114, control speed of the conveyors 104,108,112, and adjust characteristics within the sterilizer 110.

For example, the speed of the conveyor may be controlled by increasing the speed or decreasing the speed based on data obtained from the pH sensor, the humidity sensor, the particle-size sensor, the bacteria sensor, the inside temperature sensor, the outside temperature sensor, the chemical sensor, and/or the slurry level sensor, among other sensors.

According to another embodiment, a second storage container 130 may be provided in the system 100 to store food waste and other items in a sorted state. For example, separate partitions may be provided to hold dairy food waste, meat food waste, vegetable food waste, oily food waste, fruit food waste, grain-based food waste, among other food waste. Based on data obtained from sensors in the storage container 114, the computer 125 may be configured to control components of the system 100 to obtain selected types of food waste for processing and introduction into the slurry 118. In this way, the slurry 118 may be customized according to a desired composition of food waste.

In addition to customizing the composition of food waste delivered to the storage container 114, the computer 125 may be configured to control the hopper 116 to add selected additives to promote desired characteristics. For example, certain worms may desire acidic conditions and therefore ingredients are added to the slurry 119 to lower pH. Other worms may desire moist conditions and therefore ingredients are added to the slurry 119 to add moisture. One of ordinary skill in the art will readily appreciate that different characteristics may be obtained through selection of additives.

When the sensors detect that the slurry 118 has reached desired conditions, the computer 125 may generate an alert. The alert may be transmitted electronically to a plurality of devices, including local devices and remote devices. For example, the alert may be transmitted to a remote device associated with a waste management company that may respond by dispatching a truck to withdraw the slurry 118 from the storage container 114. Alternatively, the alert may be transmitted to a local device associated with a facility proximate to the storage container 114. According to one embodiment, the alert may include a list of characteristics corresponding to the slurry 118. The list of characteristics may be used to identify a relative quality of the slurry 118 and may be used to assign a monetary value to the slurry 118.

According to another example, the storage container may be a passive container that simply stores the slurry 118. In this case, the passive storage container may be emptied when a gauge identifies that the storage container has reached a threshold capacity. For passive storage containers, processing of the slurry may occur off-site.

Various embodiments relate to a system for utilizing restaurant waste comprising food products. The system may include a grinder adapted to grind the restaurant waste to produce ground restaurant waste. The ground restaurant waste can having a maximum particle size as already specified.

The system may further include a storage container adapted to receive the ground restaurant waste and water, the storage container comprising an agitator adapted to maintain the restaurant waste and the water in the form of a slurry.

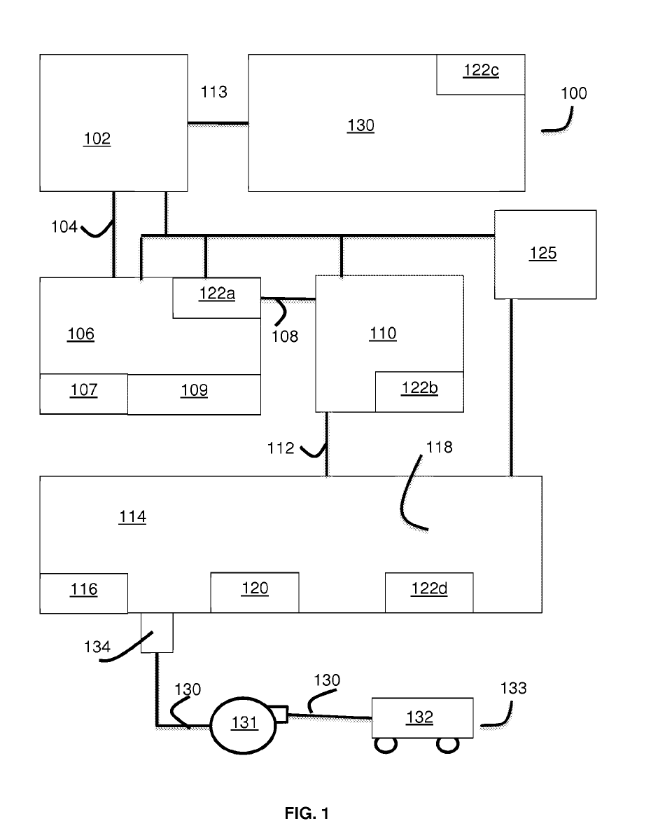

As illustrated in FIG. 1, the system may include one or more tubular connecting elements 130; one or more pumps 131; and a vehicle 133 comprising a tank 132. The one or more tubular connecting elements can include pipes, hoses, or tubes having the sizes and properties describe herein with respect to the various processes for utilizing restaurant waste. The one or more tubular connecting elements may be adapted to move the slurry from the storage container 114 to the tank 132 via a pump 131. The vehicle 133 may be any vehicle, such as a truck, adapted to transport the slurry to a processing facility, particularly a processing facility suitable for feeding the slurry to one or more organisms.

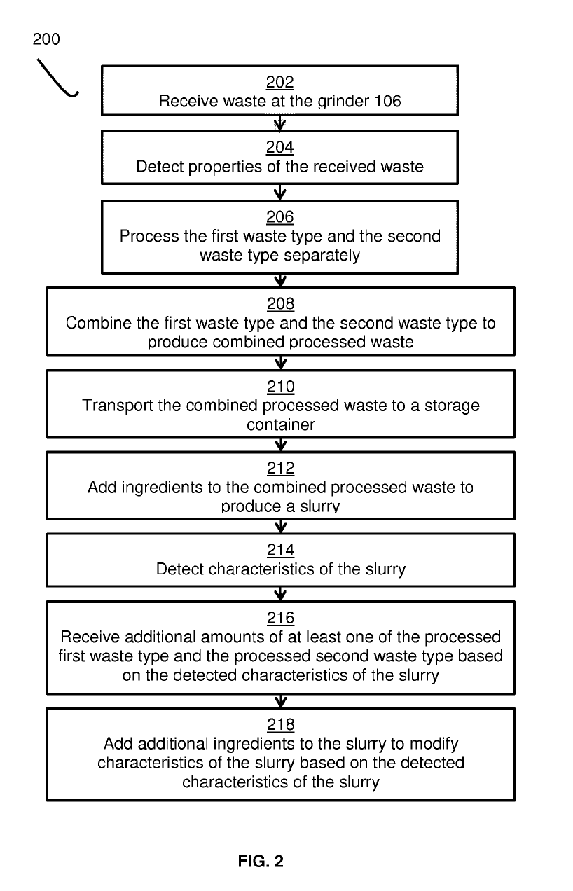

FIG. 2 illustrates a flow chart of an example method 200 according to the present disclosure. The method 200 may be implemented using one or more of the above-described components. For example, the method 200 may be implemented by the various components of the system 100 under the control of the computer 125.

For example, the computer 125 may be communicatively coupled to the various components of the system 100 such as by a wired connection or a wireless network connection.

According to one example, the method 200 may include receiving waste at the grinder 106 in operation 202. The waste may include a first waste type such as wet and/or soft food waste, along with paper products. The grinder additionally may receive a second waste type such as hard food waste, along with non-food items such as packaging made from glass, plastic, or the like. One of ordinary skill in the art will readily appreciate that more than two waste types may be supported by the technology. For example, a third waste type may include an oil or a liquid waste type that is introduced into the grinder 106 for processing.

In operation 204, properties of the received waste may be detected in order to determine whether the waste is of the first waste type or the second waste type. For example, a density sensor may be employed at the grinder 106 that scans each article of the received waste. When the first waste type is detected, the corresponding waste article may be transported to a first section of the grinder 106 that is equipped to blend the wet and/or soft food waste, along with paper products. When the second waste type is detected, the corresponding waste article may be transported to a second section of the grinder 106 that is equipped to crush the hard food waste, along with non-food items such as packaging made from glass, plastic, or the like. Accordingly, the detected properties of the received waste are analyzed and applied to separate the received waste into the first waste type and the second waste type. In operation 206, the first waste type and the second waste type are processed separately. After separation, the first waste type and the second waste type may be maintained in separate storage areas of the grinder 106. Alternatively, the first waste type and the second waste type may be blended or combined to produce combined processed waste in operation 208.

In operation 210, the combined processed waste, the first waste type, and/or the second waste type may be transported via one or more conveyors 104,108,112,113 to the storage container 114. The transport speed of the conveyors 104,108,112,113 may be adjusted for various reasons. For example, the transport speed of the conveyors 104,108,112,113 may be increased or decreased depending on the properties of the received waste, the first waste type, and the second waste type passing through the system 100. According to one example, the transport speed of the conveyors 104,108,112,113 may be increased such as through the sterilizer 110 when the second waste type passes through the system 100 and includes glass without any hard food items. Alternatively, the transport speed of the conveyors 104,108,112,113 may be decreased such as through the sterilizer 110 when the first waste type passes through the system 100 and includes raw and/or undercooked poultry, which has a high probability of causing food-borne illness. One of ordinary skill in the art will readily appreciate that other conditions exist for adjusting the speed of the conveyors 104,108,112,113 through the system 100.

When the processed food waste is deposited into the storage container 114, ingredients may be added into the storage container 114 from the hopper 116 to produce the slurry 118 in operation 212. According to one example, the ingredients may be added into the slurry 118 to modify at least one of the pH, the humidity, the particle-size, the bacteria level, the bacteria type, the slurry temperature, the chemical composition, and the slurry level, among other things. In this way, characteristics of the slurry 118 may be detected in operation 214 to identify ingredients to be added into the slurry 118.

According to one example, the slurry 118 may be customized to promote desired characteristics, such as to neutralize odors or to deter consumption by rodents. Furthermore, the slurry 118 may be customized for consumption by particular worms. In operation 216, characteristics of the slurry 118 may be modified by receiving additional amounts of at least one of the processed first waste type and the processed second waste type. For example, if a particular worm specie prefers the slurry 118 with a larger grain size, then the computer 125 may communicate with the grinder 106 to obtain additional amounts of the second waste type such as more crushed class particles. Alternatively, if a particular worm specie prefers the slurry 118 with higher bacteria levels, then the computer 125 may communicate with the grinder 106 to obtain additional amounts of the first waste type such as more raw poultry. One of ordinary skill in the art will readily appreciate that other waste types may be added to the slurry 118.

According to yet another example, when the slurry 118 receives the additional amounts of at least one of the processed first waste type and the processed second waste type, the computer 125 may be programmed to add additional ingredients to the slurry 118 in operation 218 to modify characteristics of the slurry 118. For example, the computer 125 may be programmed to add additional pH neutralizing ingredients to the slurry 118 if a particular worm specie prefers the slurry 118 to include higher bacteria levels. One of ordinary skill in the art will readily appreciate that other ingredients may be added to the slurry 118.

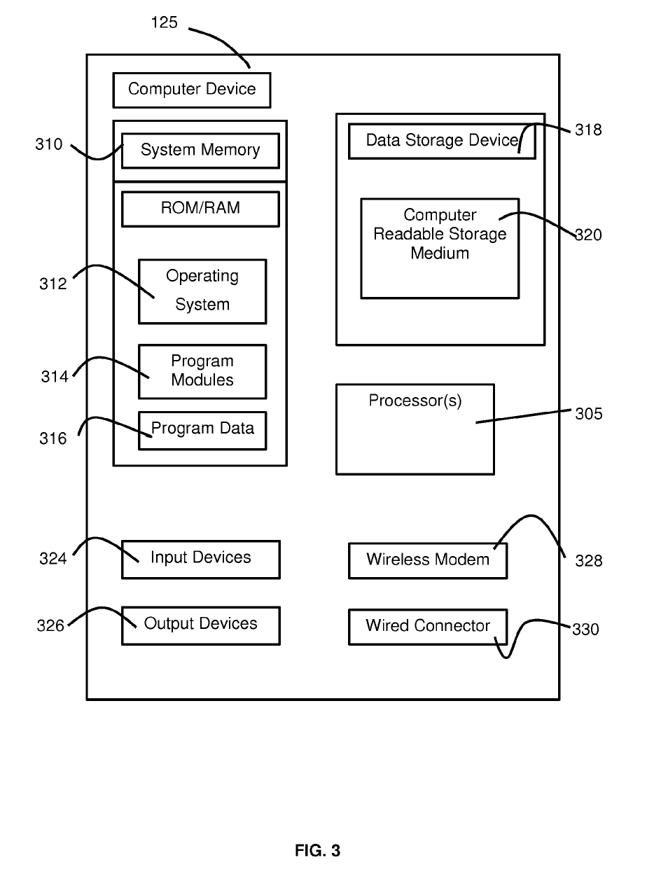

FIG. 3 illustrates a block diagram 300 of the computer 125 for controlling the system 100 according to one example. The computer 125 includes one or more processors 305, such as one or more CPUs, microcontrollers, field programmable gate arrays, or other types of processing devices. The computer 125 also may include a system memory 310 that may correspond to any combination of volatile and/or non-volatile storage memory. The system memory 310 stores information, which provides an operating system component 312, various program modules 314, program data 316, and/or other components. The computer 125 performs functions by using the processor(s) 305 to execute instructions provided by the system memory 310.

The computer 125 also may include a data storage device 318 that may be composed of one or more types of removable storage and/or one or more types of non-removable storage. The data storage device 318 may include a computer-readable storage medium 320 on which is stored one or more sets of instructions embodying any one or more of the functions of the computer 125, as described herein. As shown, instructions may reside, completely or at least partially, within the (non-transitory) computer-readable storage medium 320, system memory 310 and/or within the processor(s) 305 during execution thereof by the computer 125. The system memory 310 and the processor(s) 305 also may constitute computer-readable media. The computer 125 also may include one or more input devices 324 (a keyboard, a mouse device, specialized selection keys, etc.) and one or more output devices 326 (displays, printers, audio output mechanisms, etc.).

According to one example, the computer 125 may further include a wireless modem 328 (or other such wireless communication component(s)) to allow the computer 125 to communicate via a wireless network (e.g., such as provided by a wireless communication system) with other devices, such as remote devices including the grinder 106, the sterilizer 110, and components associated with the storage container 114. The wireless modem 328 may provide network connectivity through a private network, a public network, or both, such as the Internet, a local area network (LAN), a public switched telephone network (PSTN), or the like, to allow the computer 125 to communicate with the other devices in addition to additional devices, such as server computing systems, telephone devices, or the like. The computer 125 also may wirelessly connect with the other devices and additional devices by forming a wireless ad hoc (peer-to-peer) network with another device. Additionally, the wireless infrastructure may be provided by one or multiple wireless communications systems such as a local area network (WLAN) hot spot connected with the network. The WLAN hot spots can be created by Wi-Fi® products based on IEEE 802.11x standards by Wi-Fi Alliance. Alternatively, the remote devices may be connected via wired connections such as through a wired connector 330.

In the above description, numerous details are set forth. However, it will be apparent to one of ordinary skill in the art having the benefit of this disclosure that exampled may be practiced without these specific details. In some instances, well-known structures and devices are shown in block diagram form, rather than in detail, in order to avoid obscuring the description.

Examples provided herein describe a computer that performs the operations. This computer may be specially constructed for the required purposes or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, or any type of media suitable for storing electronic instructions.

The specification and drawings are to be regarded in an illustrative rather than a restrictive sense. It will, however, be evident that various modifications and changes may be made without departing from the broader spirit and scope of the invention as set forth in the following claims.

What is claimed is:

1. A process for utilizing restaurant waste produced at a restaurant, the restaurant waste comprising food products, the process comprising:
grinding the restaurant waste at the restaurant to produce ground restaurant waste;
forming a slurry at the restaurant, the slurry comprising the ground restaurant waste and water; and
storing the slurry in a storage container at the restaurant.

2. The process according to claim 1, wherein the ground restaurant waste has a maximum particle size of from about 0.075 mm.

3. The process according to claim 1, further comprising maintaining the slurry at a pH greater than about 7 in the storage container.

4. The process according to claim 1, wherein the restaurant waste further comprises one or more selected from the group consisting of paper products, glass products, plastic products, and combinations thereof.

5. The process according to claim 1, wherein the food products comprise bones.

6. The process according to claim 1, further comprising sterilizing the ground restaurant waste by exposing the ground restaurant waste to one selected from the group consisting of ultra-violet radiation, microwave radiation, heat energy, ozone, and combinations thereof.

7. The process according to claim 6, wherein sterilizing the ground restaurant waste occurs prior to maintaining the slurry in the storage container.

8. The process according to claim 1, further comprising agitating the slurry in the storage container.

9. The process according to claim 1, wherein the storage container is airtight.

10. The process according to claim 1, wherein the storage container has a storage volume of at least 50 gallons.

11. The process according to claim 1, further comprising pumping the slurry from the storage container to a tank of a vehicle and transporting the slurry to a processing facility.

12. The process according to claim 11, wherein the storage container comprises a pumping connection through which the slurry is pumped, and wherein the pumping connection is positioned in a lower portion of the storage container.

13. The process according to claim 11, further comprising feeding the slurry to one or more digestive organisms at the processing facility.

14. The process according to claim 13, wherein the one or more digestive organisms include worms.

15. The process according to claim 13, wherein the one or more digestive organisms include one selected from the group consisting of bacteria, fungi, molds, and combinations thereof.

16. The process according to claim 13, further comprising analyzing the slurry to identify a characteristic of the slurry; and adjusting the characteristic according to the requirements of the one or more digestive organisms.

17. The process according to claim 16, wherein the characteristic is selected from the group consisting of pH, water content, particle size, temperature, and combinations thereof.

18. A system for utilizing restaurant waste comprising food products, the system comprising:
a grinder adapted to grind the restaurant waste to produce ground restaurant waste,
the ground restaurant waste having a maximum particle size of about 0.075 mm; and
a storage container adapted to receive the ground restaurant waste and water, the storage container comprising an agitator adapted to maintain the restaurant waste and the water in the form of a slurry.

19. The system according to claim 18, further comprising a sterilizer that applies at least one of ultra-violet radiation, microwave radiation, heat energy, and ozone to the ground restaurant waste to sterilize the ground restaurant waste.

20. The system according to claim 18, wherein the storage container has a storage capacity of at least 50 gallons.

21. The system according to claim 18, further comprising one or more tubular connecting elements;
a pump; and
a vehicle comprising a tank,
wherein the one or more tubular connecting elements are adapted to move the slurry from the storage container to the tank, wherein the vehicle is adapted to transport the slurry to a processing facility.

22. The system according to claim 18, wherein the grinder comprises a first section that processes a first waste type and a second section that processes a second waste type to produce the ground restaurant waste;
the system further comprising:
a hopper provided in fluid communication with the storage container, the hopper including ingredients that are added to the processed waste to produce a slurry;
a first sensor provided in the grinder to detect properties of the waste, the first waste type, and the second waste type;
a second sensor provided in the storage container to detect characteristics of the slurry; and
a processor that is communicatively coupled to the grinder, the hopper, the first sensor, and the second sensor, the processor communicating with a computer-readable storage medium having instructions stored thereon that, when executed by the processor, cause the system to:
control properties of the first section and the second section of the grinder based on the detected properties of the restaurant waste; and
add additional ingredients to the ground restaurant waste based on the detected characteristics of the slurry.

23. The system of claim 22, wherein the first sensor includes a density sensor that distinguishes between the first waste type and the second waste type and wherein the instructions, when executed by the processor, cause the first waste type to be delivered to the first section and the second waste type to be delivered to the second section.

24. The system of claim 22, wherein the second sensor includes at least one of a pH sensor, a humidity sensor, a particle-size sensor, a bacteria sensor, an inside temperature sensor, an outside temperature sensor, a chemical sensor, and a slurry level sensor.

25. The system of claim 22, wherein the instructions, when executed by the processor, cause the additional ingredients to be added to the ground restaurant waste based on data obtained from the second sensor.

26. The system of claim 22, further comprising:
a sterilizer that applies at least one of ultra-violet radiation, microwave radiation, heat energy, and ozone to sterilize the processed waste; and
a third sensor provided in the sterilizer to detect properties of the first waste type and the second waste type introduced into the sterilizer.

27. The system of claim 26, wherein the instructions, when executed by the processor, cause the sterilizer to activate and de-active the at least one of the ultra-violet radiation, the microwave radiation, and the heat energy to activate or de-activate based on the detected properties obtained from the third sensor.
